(19) United States
(12) Patent Application Publication
(10) Pub. No.: US 2020/0326735 A1
(43) Pub. Date: Oct. 15, 2020

(54) THERMOSTAT SYSTEM

(71) Applicant: Venstar, Inc., Chatsworth, CA (US)

(72) Inventor: Steven Dushane, Granada Hills, CA (US)

(73) Assignee: Venstar, Inc., Chatsworth, CA (US)

(21) Appl. No.: 16/912,344

(22) Filed: Jun. 25, 2020

Related U.S. Application Data
(63) Continuation of application No. 15/823,497, filed on Nov. 27, 2017.

(51) Int. Cl. G05D 23/24; G05D 23/19; G05D 23/30; F24F 11/58; F24F 11/00; F24F 11/52; G05B 19/042; G05B 15/00; G05B 15/02

(52) U.S. Cl. CPC G05D 23/24; G05D 23/1904; G05D 23/30; F24F 11/58; F24F 11/523; F24F 11/52; G05B 19/042; G05B 15/00; G05B 15/02; F24F 11/00

(57) ABSTRACT

A thermostat system comprises a thermostat located on the inside of the building, comprising (i) a screen display, (ii) a control input for receiving thermostat programming information, and (iii) interface circuitry for coupling to an environmental system comprising one or more items of equipment selected from the group heating, ventilation, and air conditioning equipment. A doorbell is located on the outside of said building. Optionally a camera may be located proximate said doorbell.

### RELATED APPLICATION INFORMATION

The present application is a continuation application of U.S. application Ser. No. 15/823,497 entitled “THERMOSTAT SYSTEM” filed on Nov. 27, 2017, the disclosure of which is incorporated herein by reference in its entirety.

### STATEMENT REGARDING FEDERALLY SPONSORED RESEARCH OR DEVELOPMENT

(Not applicable)

### BACKGROUND OF THE INVENTION

### Technical Field

In accordance with the present invention, locally and remotely communicated recognition functions keyed to environmental control objectives are integrated into a programming priority and security functionality in an HVAC control system.

### Background of the Invention

Today, numerous so-called smart home systems are used to control various appliances in the home, such as environmental systems, coffee makers, lighting, music and so forth. However, such systems are relatively expensive and generally require the consumer to buy relatively expensive infrastructure in terms of control systems to integrate various appliances together. Moreover, integration of control of existing appliances is not often practical because most appliances sold today and those which are already in use were designed as self-contained devices.

The invention relates to apparatus and methods for controlling heating, ventilation and air-conditioning systems while at the same time providing security without significant marginal hardware manufacturing costs.

Moreover, while the idea of a smart home with appliances responsive to the central control system is attractive, as a practical matter the concept is lacking for numerous reasons and this explains why, despite the availability of the technology at very competitive prices, no widespread adoption of such systems has occurred. Some of the problems associated with such systems are addressed by the present invention.

### SUMMARY OF THE INVENTION

In accordance with the invention, it has come to be recognized that electronic systems fall into two categories, namely a first category of systems, such as appliances which may be desirably used in different locations, may be stored out of sight when not in use, and which, when they are used take up valuable counterspace, for example in the kitchen. A conventional CD player or DVD player comprising an apparatus for receiving a disk and outputting to a performance device such as a television set, video monitors and or speakers also falls within this first category.

A second category of systems by their nature take up minimal space and almost require that they be easily accessible or exposed at all times, and may be maintained, most often, at a single location. The applicant has also come to recognize that this category includes devices such as doorbells, door unlocking mechanisms, garage door openers and thermostats. In the second category of systems, with the exception of thermostats, almost no control mechanisms are generally employed, because they are simply not needed.

Unlike coffee makers which must be responsive to the amount of coffee being brewed, or a CD player which requires the user to insert a disk, systems in this second category involve simple on-off functions. While this is also true of thermostats, thermostats are different in so far as they are advantageously programmed with an algorithm which enables them to maintain environmental parameters within a desired range of values. As a result, thermostats were among the first appliances to receive a significant amount of computing power. More recently, because of the complexity of programming the same, thermostats have begun to experience the commercial implementation of sophisticated navigation devices, including LED displays and touchscreen capabilities.

In a latest iteration, these touchscreen programmable thermostats have also come to incorporate a Wi-Fi capability which enables them to access and be accessed by a Wi-Fi router of the type used in homes. This wireless accessing feature allows thermostat control functions to be programmed by and send information to a remote digital device, such as a smart phone or personal computer. Accordingly, using such systems, a homeowner may monitor environmental conditions in a room (or a plurality of rooms if a plurality of thermostats are situated in a number of rooms), monitor other environmental conditions (such as outside temperature, wind speed, and humidity), and program the thermostat remotely.

With the objective of maintaining cutting-edge thermostat functionality, the Wi-Fi capability of the thermostats may also be used to allow them to download updated software addressed, for example, at maintaining functionality with newly introduced equipment, implementing improved environmental control algorithms, and so forth. Such systems thus introduce the possibility of a versatile, updatable and multifunction control system which may be remotely programmed, overridden or controlled remotely.

It is generally accepted that an environmental control system, such as a thermostat is an essential element in a home. Likewise, another system generally accepted as essential is a doorbell. Such systems are of extremely simple design, generally involving an electrical single pole single throw switch, a low voltage power supply and a mechanical bellringer, gong or buzzer. Where possible, some means of visually identifying a visitor, most often the wide-angle telescope associated with an apartment front door mechanical bell.

The present invention takes advantage of the commonality in the functions of doorbells and thermostats to provide enhanced operation in both systems. An artificial intelligence algorithm downloaded into the system, for example into the thermostat (which is preferred on account of its sheltered location), enable it to receive video data from a video camera associated with the doorbell “button.” In response to the detection of a dangerous condition, for example erratic movement of an individual at a doorbell, the system may ask for a confirmation before enabling a visitor to enter the dwelling.

Likewise, facial feature or other recognition strategy may be used to indicate a potentially dangerous situation. For example in addition to recognizing the identity of an individual, the video image may also be analyzed to indicate whether the individual is angry or in some other dangerous psychological state.

These various methodologies allows the system to assess potentially dangerous situations and present a warning message on the same touchscreen face used to program the thermostat. The connection of the doorbell to the thermostat via the Wi-Fi router also enables the occupant of the dwelling to see the person at the door.

Yet another advantageous aspect of the invention is the fact that thermostats require a significant amount of computing power. By providing the thermostat with a means for Wi-Fi communication and programmability, the same computing power may be used for control of extraneous appliances in any category. Thus, the consumer, at virtually no additional cost, or very little additional cost, can acquire a device for controlling temperature while creating the option for receiving programming allowing remote, programmed, or other control of a wide variety of devices, such as lighting, audio and other equipment with very modest marginal costs.

### BRIEF DESCRIPTION THE DRAWINGS

The operation of the inventive system will become apparent from the following description taken in conjunction with the drawings, in which:

FIG. 1 is a system block diagram illustrating a general implementation of the present invention;

FIG. 2 is a diagrammatic representation of the thermostat useful for practicing the methodology of the present invention;

FIG. 3 illustrates the programming of the thermostat of FIG. 2;

FIG. 4 illustrates the display of the thermostat program as implemented according to the present invention;

FIG. 5 is a flowchart illustrating the methodology of the present invention;

FIG. 6 illustrates an alternative embodiment of the methodology of the present invention having a facial identity and/or emotional/circumstantial detection feature; and

FIG. 7 illustrates yet another embodiment of the methodology of the present invention.

### DETAILED DESCRIPTION OF THE PREFERRED EMBODIMENTS

In accordance with the present invention, locally and remotely reported recognition functions keyed to environmental control objectives are integrated into a priority and security functionality.

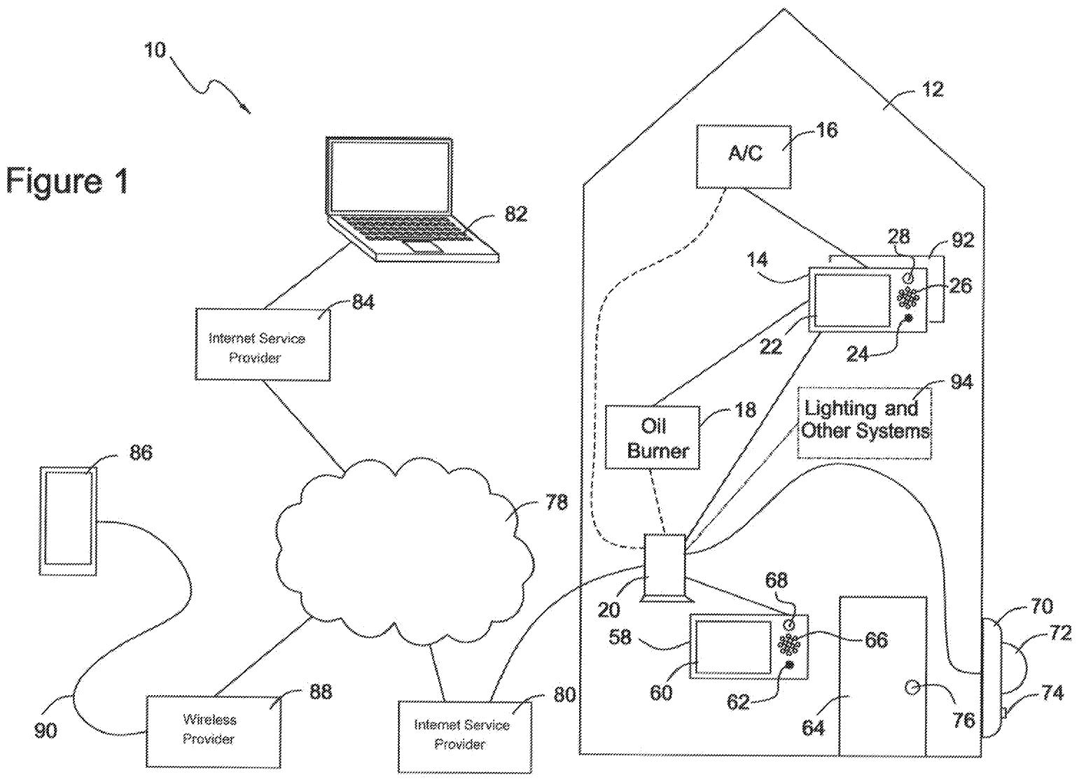

More particularly, with reference to FIG. 1, in accordance with the invention, a system 10 is illustrated which provides to a building 12, such as a home or commercial facility, enhanced HVAC functions keyed to recognition, wherein the condition information is also utilized to enhance system security.

More particularly, a smart thermostat 14 is located in house 12 and controls, among other things, the operation of air-conditioning equipment 16 and oil burner 18. Air-conditioning equipment 16 and oil burner 18 may be hardwired to smart thermostat 14. Alternatively, air-conditioning equipment 16 and oil burner 18 may be connected to smart thermostat 14 via a router 20. Thermostat 14 may include conventional smart thermostat functions, such as programmability featuring multiple periods a day with specific heating and air-conditioning objectives, vacation days, overrides, and so forth.

In accordance with the invention, it is contemplated that thermostat 14 will incorporate an LCD touchscreen 22. Touchscreen 22 may be used to present programming menus including programming periods, such as morning, day, evening and night together with menus allowing the setting of heating and air-conditioning equipment. Menus may be provided for the variation of the time at which programming periods begin and end. Thermostat 14 also incorporates a microphone 24 and a loudspeaker 26 to enable the intercom functionality of the inventive system 10.

Video capability is provided by a camera 28. Optionally, thermostat 14 may be positioned substantially below eye level, for example 2 feet below eye level for a person who is 5 feet 6 inches tall (or even lower, for example at the height of the waist for a person of average height), and LCD display 22 may be tilted to aim directly at the eyes of the user.

In one particularly preferred embodiment, thermostat 14 is installed approximately at the height of the elbow of an average person. For example about 43 inches from the floor. For an individual whose eyes are at a height of 61 inches above the floor on which the person is standing, if the individual is standing with his or her eyes 17.5 inches from the wall, a display position 43 inches from the floor would be tilted at an angle of approximately 55° from the horizontal to result in the line of sight between the eyes and the middle of the display which substantially coincides with an imaginary vertical line perpendicular to and extending from the middle of the face for of the display. In accordance with the invention, it is contemplated that the angle with respect to the horizontal may be within the range between 35° and 75°, although having the angle within the range of 45° to 65° is preferred, and selecting the angle within the range between 50° and 60° is most preferred. Optionally, display 22 may be mounted for angular movement to accommodate user preference, for example allowing adjustment between 45° and 65° with respect to the horizontal.

As alluded to above, touchscreen display 22 is used to provide a video display, for example, any desired display, such as control, video images of a party with whom communication is being had, and so forth. A microphone 24, which may be of any conventional type, for example a piezoelectric microphone, is provided to enable audio communication between the occupant of the house and another party. Received audio signals from such other party may be played back through a loudspeaker 26, such as an electromagnetic paper cone loudspeaker. Audio generated by microphone 24 may be communicated in conjunction with video generated by a camera 28.

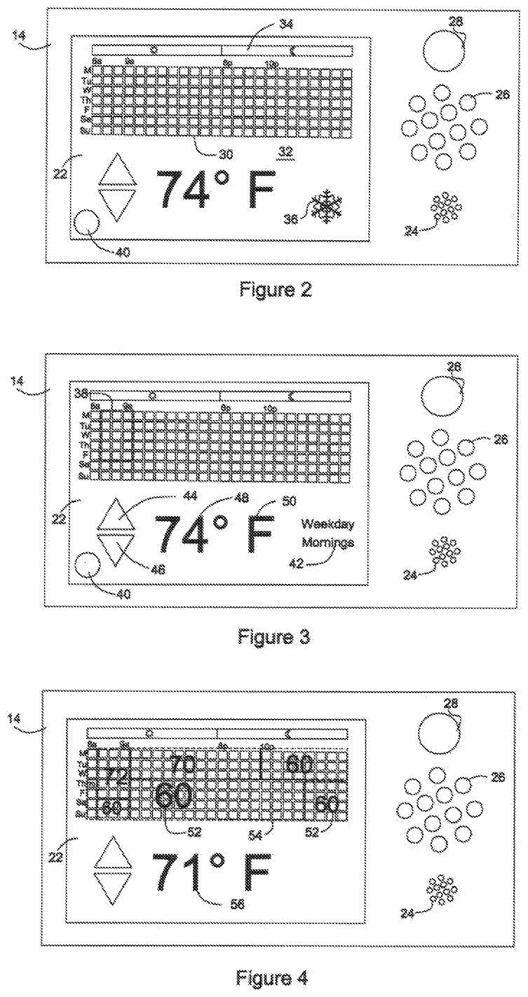

Display 22 may also be used for other purposes, such as alternative programming display graphic user interfaces. For example, as an alternative to programming periods, menus may be provided to allow the individual programming of times at which various temperatures may be maintained. One option, as is illustrated in FIG. 2, is the presentation of a matrix of hours, for example a matrix 30 which has 24 columns signifying the 24 hours of the day and seven columns signifying the seven days of the week.

A menu may be provided to present this matrix for four different seasons which are color differentiated according to season, for example, by presenting the 24 hour and seven day matrix with a blue background 32 for winter, a green background for spring, and orangeish red for summer, and a dark yellow for fall.

The display may also include a scale 34 indicating day and night and a seasonal indicator 36, showing, for example, a snowflake to indicate that the season is winter.

Programming of thermostat 14 may be initiated in conventional fashion by selecting a period of a week, day, or the like using conventional touch screen techniques to create a box 38, as shown in FIG. 3. Alternatively, individual elements in the 24 by 7 matrix may be tapped to individually bring them into a programming group. In connection with this, the system may be designed in such a manner that it is not necessary that all the time/temperature segments be continuous. Any time/temperature segments not programmed will revert to default factory settings.

In accordance with the present invention, it is contemplated that once a group has been selected, that touching the screen would release the group allowing a change in the programming. Accordingly, a virtual control key 40 may be provided which the user would press with one finger while inputting multiple tapping and dragging inputs without erasing prior inputs, in much the same fashion as the control key on a personal computer directory in Windows® allows the highlighting and selection of multiple files without erasing previous selections when the control key is depressed.

Thermostat 14 may also present a display 42 indicating verbally the time, being programmed as a double check for the individual doing the programming. The same may be implemented with an artificial intelligence algorithm selecting from a number of potential displays and presenting one or more of them depending upon the time period selected, and user input.

In accordance with the invention, temperature may be varied by pressing virtual touchscreen keys 44 and 46 to respectively raise and lower the temperature being programmed. The temperature being programmed is indicated by display 48, which also includes a display 50 indicating whether the temperature is being programmed in centigrade or Fahrenheit.

Turning to FIG. 4, the inventive system also contemplates a display of all programming when the thermostat is not being programmed. In accordance with the invention, this may be done by the use of temperature indicators 52 and time block indicators 54. A display 56 is also provided to show the actual temperature being detected by thermostat 14.

Returning to FIG. 1, inventive system 10 comprises a doorbell communicator 58. Doorbell communicator 58 comprises an LCD touchscreen display 60 for presenting video, virtual keys for operation of the system, a greeting and so forth.

Doorbell communicator 58 may also be provided with a microphone 62 for enabling simplex, half duplex or duplex communication. In accordance with one particularly preferred embodiment, more than two devices, for example two thermostats (for example in different rooms) may be used to communicate with an individual operating a doorbell communicator 58 at, for example, the front door 64 of a home or office.

Audio for communication between the occupant of the house or office 12 positioned at thermostat 14 is provided by speaker 66. A video image of the individual at the door is provided by a video camera 68.

In one particularly preferred embodiment, doorbell communicator 58 is installed approximately at the height of the elbow of an average person, for example about 43 inches from the floor. For an individual whose eyes are at a height of 61 inches above the floor on which the person is standing, if the individual is standing with his or her eyes 17.5 inches from the wall, a display position 43 inches from the floor is to be oriented at an angle of approximately 55° from the horizontal to result in a line of sight between the eyes and the middle of the display which substantially coincides with an imaginary vertical line perpendicular to and extending from the middle of the display. In accordance with the invention, it is contemplated that the angle with respect to the horizontal may be within the range between 35° and 75°, although having the angle within the range of 45° to 65° is preferred, and selecting the angle within the range between 50° and 60° is most preferred. Optionally, display 60 may be mounted for angular movement to accommodate user preference, for example allowing adjustment between 45° and 65° with respect to the horizontal.

An alternative lower-cost externally located doorbell communicator 70, which may be located, for example, on the side door or the back door of the home, is illustrated in FIG. 1. Doorbell communicator 70 may optionally include a camera 72 and a mechanical pushbutton 74. Doorbell communicator 70 may also include a microphone and speaker, not unlike microphone 62 and speaker 66 in doorbell communicator 58.

The positioning of doorbell communicator 70 may be made different from that of doorbell communicator 58, insofar as there may not be an LCD touchscreen, but only a simple mechanical button. Accordingly, there is no need to tilt the screen and there is no requirement that it be positioned for easy viewing. Accordingly, doorbell communicator 70 may be positioned for easy operation of mechanical pushbutton switch 74, for example at a height similar to doorknob 76 on door 64.

As noted above, thermostat 14 may control air-conditioning equipment 16 and oil burner 18 in conventional fashion through the use of hardwired circuits located in the house. Alternatively, thermostat 14 may communicate with router 20 using its Wi-Fi capability, while air-conditioning equipment 16 and oil burner 18 may also be provided with Wi-Fi capability enabling them to communicate with thermostat 14 through router 20, as shown in dashed lines in FIG. 1.

Regardless of the method of control between air-conditioner 16 and oil burner 18 on the one hand and thermostat 14, on the other hand, thermostat 14 may be accessed via a public communications network, such as the Internet such access may be provided by an Internet service provider 80. This enables a remote computing device, such as a personal computer 82, accessing the Internet 78 via an Internet service provider 84 to control the programming and operation of thermostat 14, and thus control oil burner 18 and air-conditioner 16.

In accordance with a preferred embodiment of the invention, means may also be provided for personal computer 80 to directly access oil burner 18 and air-conditioner 16 through router 20.

In a fashion similar to the control of thermostat 14 by direct control of the components of the HVAC system in home 12, control may be exercised using a smart phone 86 accessing the Internet 78 through a wireless provider 88 over a wireless channel 90.

In accordance with the invention, additional thermostats, such as thermostat 92 may be provided in multiple zones. Such additional thermostat or thermostats 92 may be provided with connectivity the same or equivalent to the conductivity of thermostat 14. Thermostat 92 has features identical to thermostat 14, including a microphone 24, a loudspeaker 26, a video camera 28 and a touchscreen 22 (not illustrated).

Optionally, the computing infrastructure, Wi-Fi and web conductivity of thermostat 14 may be used to allow control of other appliances in the home, such as lighting 94, as illustrated in phantom lines in FIG. 1. For example, the system may be programmed to shut off all lights except low-power hall lighting. Likewise, heavy-duty appliances, such as ovens, close dryers and so forth may be disabled during certain periods, for example between eleven in the evening and six in the morning. The system may also be programmed to automatically shut off ovens and kitchen range burners after, for example, two hours of operation, or a smaller period of time if that is consistent with the user's customary cooking operations. This results in saving power and promoting safety.

This approach has particular value because the cost of additional Wi-Fi capability can be reserved to the time when any additional connected equipment, such as lights, ovens or other devices are purchased.

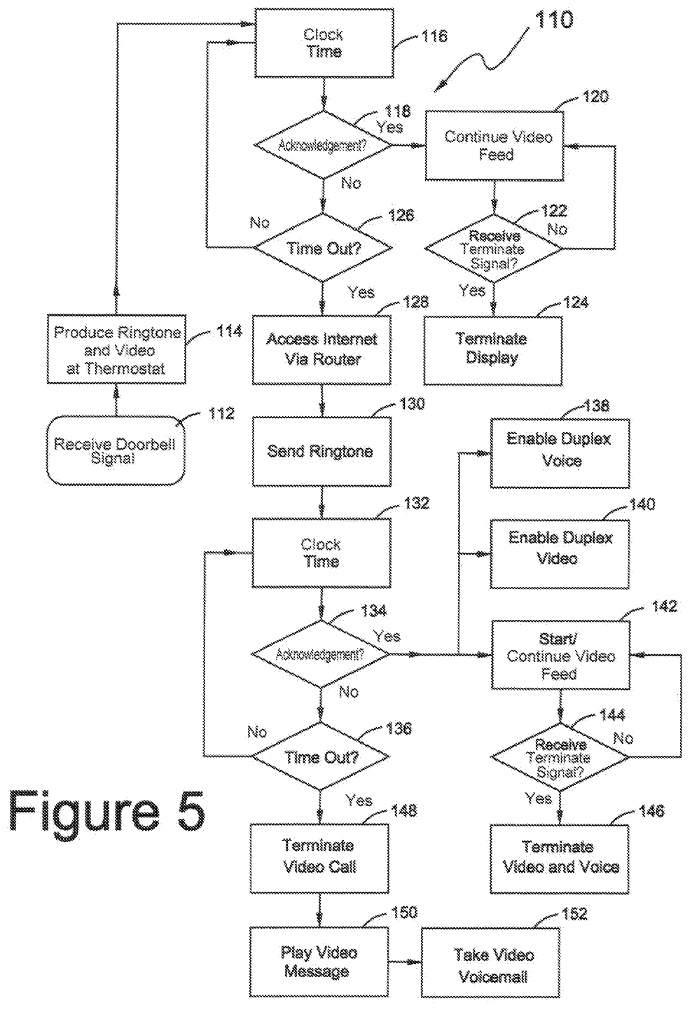

A methodology 110 which may be used to control the system 10 of the present invention is illustrated in FIG. 5. This methodology may be implemented in software running on a microprocessor, such as a RISC processor. In accordance with the invention, it is contemplated that the RISC processor will be Internet connected and may be programmed remotely by the supplier of the software, for example by a thermostat and/or other controls manufacturer.

For purposes of illustration, the system will be described in connection with a thermostat system having two zones (for example a sleeping zone and a daytime zone), with two video thermostats (such as thermostat 14), a front door doorbell and a side door doorbell. At step 112, operation of system 10 is commenced by actuation of a doorbell signal at, for example, the front door of a home or office facility 12. The same may be achieved using a mechanical switch 74, or a virtual doorbell button presented on a liquid crystal display touchscreen such as touchscreen 50. Upon receiving such a signal, the system is informed of the presence of an individual seeking entry into facility 12.

The system then proceeds, in response to the pressing of the doorbell, to step 114 where ring tones are presented at the two video thermostats in the system in response to the communication of the pressing of the doorbell from the doorbell thermostat 58 through router 20 to receiving thermostats 14 and 92. At the same time, video is sent to the touchscreen displays 22 on thermostats 14 and 92, causing them to display the video signal generated by video camera 62, thus providing a measure of security to the occupant(s) by revealing to the occupants the appearance of the individual at the door, and portraying any activity in the vicinity. At the same time, audio collected by microphone 62 is presented by speaker 26, thus enabling, for example, full-duplex communication with the individual at the door.

At step 116, the system begins to measure the time during which the ring tone commenced at step 114 has been produced. After a relatively short period of time, the system checks to see if an acknowledgment signal has been received either by the presentation of audio at one of the microphones 24, or the pressing of a, for example, virtual key on the touchscreen, for example a key releasing the latch on the door and allowing the visitor at the door admission.

If acknowledgment has been received at step 118, the video and audio communication channel is maintained at step 120. At step 122, the system tests whether a termination signal has been received, such as the opening of the latch at door 64. If the termination signal has not been received, the system returns to step 120 to continue the video feed. On the other hand, if a termination signal has been received the system proceeds to step 124 where the display is terminated.

If, at step 118, no acknowledgment is received, the system proceeds to step 126, where the system determines whether a preset time for producing a ring tone at thermostats 14 and 92 has expired. If the time is not expired, the system returns to step 116.

If, at step 126, the system determines that the time has expired, the system proceeds to step 128 and accesses the Internet 78 via router 20 and Internet service provider 80. The ring tone instituted, at doorbell communicator 58 is then sent at step 130 via the Internet to remote personal computer 82 through its Internet service provider 84. At the same time, at steps 128 and 130 the ring tone instituted at doorbell communicator 58 is also sent via the Internet to remote smart phone 86 via its wireless provider 88, for example in much the same way as weather and other emergency alerts are currently sent to smart phones.

The system then proceeds to step 132 where it measures the amount of time that the alert has been transmitted via the Internet to remote personal computer 82 and smart phone 86. At step 134, if an acknowledgment of the alert has not been received, the system proceeds to step 136. If the predetermined amount of time for the alert to be sent has not expired the system returns to step 132.

If, at step 134, acknowledgment has been received, for example by pressing a virtual key on the display of personal computer 82 or smart phone 86, the system proceeds to step 138, where duplex voice communication is enabled. At the same time, at step 140 duplex video communication is enabled. In the case a smart phone 86, the communication can simply take the form of a conventional video telephone call such as that provided by Skype® or Facetime®. Such communication is started at step 142.

In accordance with a preferred embodiment, once the call has been acknowledged at step 134, the remote user at personal computer 82 or smart phone 86 may, for example by pressing a virtual key on their touchscreen, unlatch door 64 and allow the visitor access to the home or office 12.

At step 144 the system checks to see if a termination signal has been received, for example by the hanging up of smart phone 86. If no termination signal had been received, the system returns to step 142 to continue the video and audio duplex communication through the Internet. However, if a termination signal has been received, the system proceeds to step 146, where video and voice communication is terminated. At the same time, the ability of the user at remote personal computer 82 or remote smart phone 86 to allow access to the visitor at door 64 is also terminated.

In accordance with a particularly preferred embodiment of the invention, it is contemplated that before a remote user is allowed to grant access to facility 12, a security code must be input into the system.

On the other hand, if, at step 136 an acknowledgment has not been received and the time allotted for an acknowledgment to be made has expired, the system proceeds to step 148 where the video call is terminated. At the same time, an audio or video message apologizing for or explaining the reason why the call was not answered, such as a message from the homeowner or manager of the office that individual is away from his or her phone and inviting the caller to leave a message is sent at step 150, and a video or simple audio voicemail taken at step 152.

In this specification, to the extent practical, in describing alternate embodiments of the invention, analogous, identical or corresponding parts are assigned reference numerals which are multiples of 100 different from the reference numerals of their respective analogous, identical or corresponding parts.

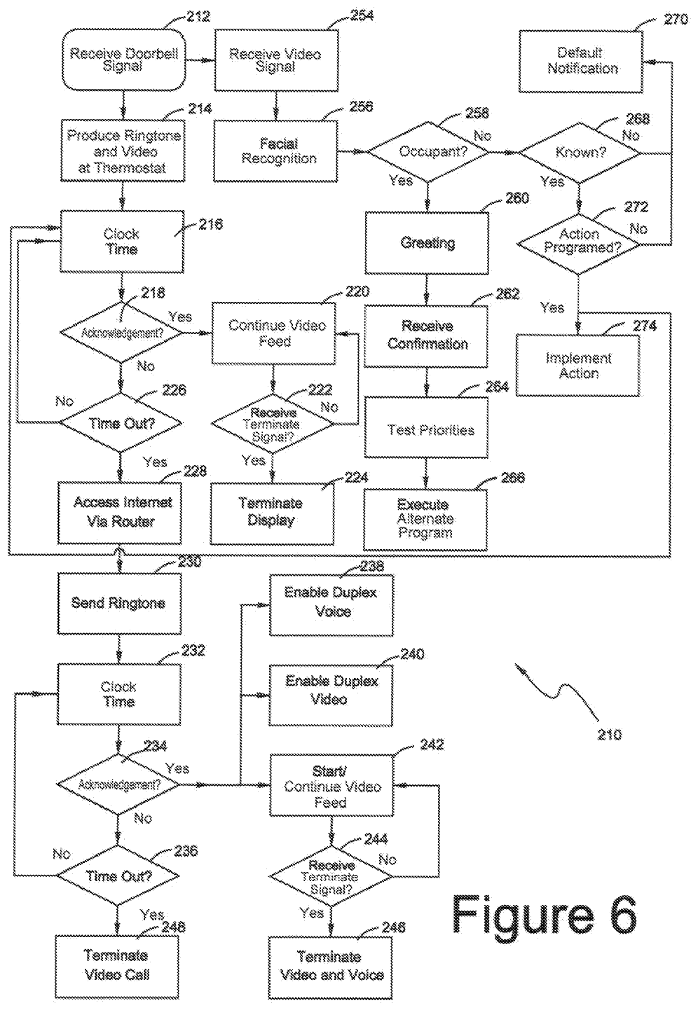

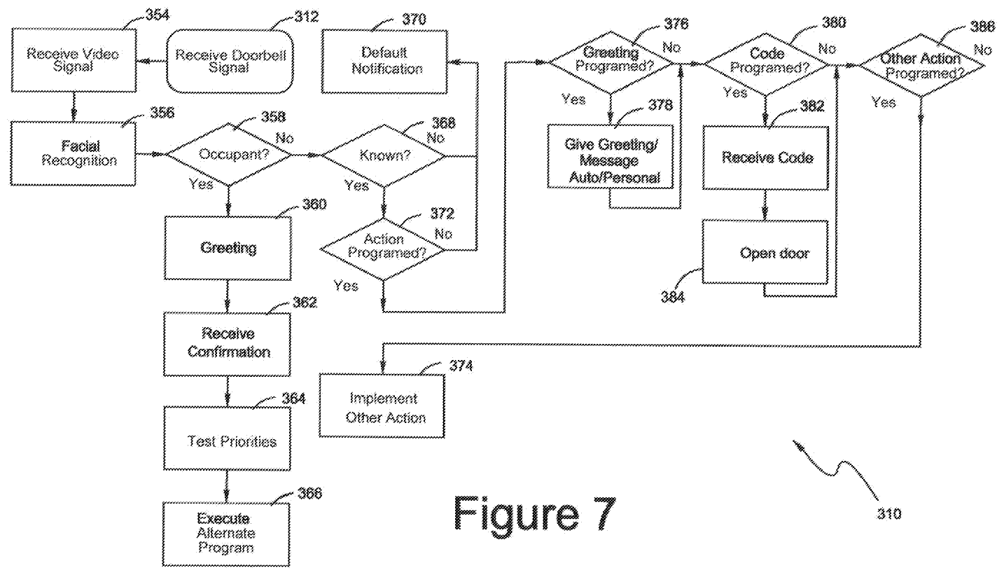

Referring to FIG. 6, an alternative embodiment of the present invention is illustrated. The inventive method 210 may be used to control, for example, system 10 illustrated in FIG. 1, as an alternative to the methodology shown and FIG. 5. More particularly, method 210 may be used to implement security functions based upon facial recognition and user preferences, requirements, priorities and security, based on perceived danger, safety, health issues preferences and priorities between preferences. Methodology 210 may be implemented in software running on a microprocessor which is Internet connected and may be programmed remotely by the supplier of the software, for example by a thermostat and/or other controls manufacturer.

For purposes of illustration, the system is described in the context of a two zone thermostat system, optionally having two video thermostats (such as thermostat 14), a front door doorbell and a side door doorbell. At step 212, operation of system 10 is commenced by actuation of a doorbell signal. The same may be achieved using any device or technique known in the art or as described herein. Upon receiving such a signal, the system is informed of the presence of an individual seeking entry into facility 12.

The system then proceeds to step 214 where ring tones are presented at the two video thermostats in the system in response to the communication of the pressing of the doorbell from the doorbell thermostat 58 through router 20 to receiving thermostats 14 and 92. At the same time, video is sent to the touchscreen displays 22 on thermostats 14 and 92, causing them to display the video signal generated by video camera 62, revealing to the occupants the appearance of the individual at the door, and portraying any activity in the vicinity. At the same time, audio collected by microphone 62 is presented by speaker 26, thus enabling communication with the individual at the door.

At step 216, the system begins to measure the time that the ring tone commenced at step 214 has been produced. After a relatively short period of time, for example 0.2 seconds, the system checks to see if an acknowledgment signal has been received.

If acknowledgment has been received at step 218, the video and audio communication channel is maintained at step 220. At step 222, the system test whether a termination signal has been received, such as the opening of the latch at door 64. If the termination signal has not been received, the system returns to step 220 to continue the video feed. On the other hand, if a termination signal has been received the system proceeds to step 224 where the display is terminated.

If, at step 218, no acknowledgment is received, the system receives to step 226, where the system determines whether a preset time for producing a ring tone at thermostats 14 and 92 has expired. If the time is not expired, the system returns to step 216.

If, at step 226, the system determines that the time has expired, the system proceeds to step 228 and accesses the Internet 78 via router 20 and Internet service provider 80. The ring tone instituted, at doorbell communicator 58 is then sent at step 230 via the Internet to remote personal computer 82. At the same time, at steps 228 and 230 the ring tone instituted at doorbell communicator 58 is also sent via the Internet to remote smart phone 86.

The system then proceeds to step 232 where it measures the amount of time that the alert has been transmitted. At step 234, if an acknowledgment has not been received, the system proceeds to step 236. If the predetermined amount of time has not expired the system returns to step 232.

If, at step 234 acknowledgment has been received, the system proceeds to step 238, and enables voice communication. At the same time, at step 240 duplex video communication is enabled.

In accordance with a preferred embodiment, once the call has been acknowledged at step 234, the remote user at personal computer 82 or smart phone 86 may, for example by verifying his identity with a security code and pressing a virtual key on their touchscreen, unlatch door 64 and allow the visitor access to the home or office 12.

In accordance with a preferred embodiment, it is further contemplated that the user at a remote personal computer 82 or a smart phone 86 will be provided with a graphical user interface which will implement the various functions described herein, including programming of the system. In addition, the microprocessor-based control in thermostat 14, for example, may be programmed for remote access from the remote personal computer or smart phone.

At step 244 the system checks to see if a termination signal has been received, for example by the operator of smart phone 86 pressing a virtual key on the phone. If no termination signal had been received, the system returns to step 242 to continue the video and audio duplex communication through the Internet. However, if a termination signal has been received, the system terminates video and voice communications. At the same time, the ability of the user at remote personal computer 82 or remote smart phone 86 to access the visitor at door 64 is also terminated.

In accordance with the embodiment of the invention illustrated in FIG. 6, receipt of a doorbell signal at step 212 also triggers, at step 254 transmission of video signals from, for example, camera 68 in response to the origin of the doorbell signal at doorbell communicator 58. Alternatively, if the doorbell signal originated at doorbell communicator 70, the output of camera 72 is transmitted at step 254.

At step 256, the video output from, for example, camera 68 is analyzed and the person at the door is identified based on the visitor's facial characteristics, stance, and so forth. At step 258 the system determines whether the person at the door is an occupant. If the individual is recognized at step 258 as an occupant, the system produces a greeting at step 260. In addition, and optionally, the individual may be asked to produce a personal or group confirmation code. Optionally, the confirmation code may be a single confirmation code for an entire family, category of workers (such as management, maintenance, sales, etc.), a single individual, and so forth.

In accordance with a preferred embodiment of the invention, when a thermostat system, such as thermostat system 210 is set up, an individual is designated as administrator. Optionally, confirmation codes may only be assigned to individuals or groups by an administrator, as a security measure. More particularly, when confirmation codes are entered the administrator must input his or her confirmation code in order for the individual or group code assignment to be effective.

In accordance with the invention, it is contemplated that each occupant of the premises may have certain preferences. For example, when a child is at home, that child may prefer to have his or her room heated at a particular temperature. A father may wish only the den and kitchen to be put at a comfortable temperature. Furthermore, preferences may be stated at various times of the day. Thus, a child may be given, during initial programming of the thermostat, freedom to control the temperature in his or her room, perhaps within overall limits set by the administrator and programmed into the system. It is thus contemplated that various temperature preferences will may be associated with particular times.

For example the father's preference of heating only the den and kitchen may only apply when he expects to return from work, perhaps between 6 PM and 7:30 PM, corresponding to the nightly news report. The father's other preferences may also be received by the system, for example having a bedroom at 62° between midnight and 5 AM.

In the business context, preferences may involve security issues. For example, remote unlatching of a door may be disabled between 11 PM and 4:30 AM. Likewise, the detected presence of security personnel may allow the program to reduce security precautions, such as by unlocking the entry door where a guard is stationed.

Returning to FIG. 6, at step 262 the system waits to receive the confirmation code from the individual at the door. If a valid confirmation code is received at step 262, the system checks to see if there is an alternate program assigned to that individual. Such an alternate program may include temperature preferences, security priorities and so forth.

Optionally, in accordance with a preferred embodiment of the invention, at step 264 the system evaluates conflicts, priorities and preferences and executes a change in the programming, if appropriate. For example, if there is no conflict, a child's preference and a father's preference may both be executed. If there is a conflict, for example in the temperature of the den, the system may be programmed to pick the lower temperature during the winter and the higher temperature during the summer. On the other hand, if there is an elderly or frail person in the home, the parameters associated with that person (for example a requirement that the temperature never exceed 78° F. during the summer) may be implemented for health and safety reasons.

After evaluating competing requirements, preferences and priorities, the system proceeds at step 266 to implement an alternative program, or to intermediate between preferences to implement compromise parameter values in accordance with algorithms programmed into the system by the user or defaults set in the system.

If, on the other hand, at step 258 the system determines that the individual is not recognized as an occupant, the system proceeds to step 268 to determine whether the individual at the door is recognized. If the individual is not recognized, a default notification sequence involving the sending of a notification to, for example the occupant of the house. In the event of a failure to receive acknowledgment over the Internet to such notification, the system will transmit the same to particular devices selected during programming of the system by the user at step 270. Alternatively, notifications may be sent to multiple occupants and multiple devices, as determined by user preference and user programming.

If, on the other hand, at step 268 the individual at the door is recognized, the system proceeds to step 272 where the system determines whether a particular action for the individual has been programmed into the system by the user. If such an action has been programmed, such action is implemented at step 274. At the same time, the system may, optionally, begin to measure the time and in accordance with the algorithm in the system, take appropriate action. Such action may be to notify certain individuals if the individual has not left within a particular period of time, notifying certain individuals immediately upon the detection of the known individual, sending the individual a message in either audio or video format or both, inviting certain action, such as placing a telephone call to a particular number, and so forth.

Yet another embodiment of the invention sharing many of the characteristics of the embodiment of FIG. 6 is illustrated in FIG. 7. After activation of a doorbell signal at step 312, at step 356, the video output from, for example, camera 68 is analyzed and the person at the door is identified based on the visitor's facial characteristics, stance, and so forth. At step 358 the system determines whether the person at the door is an occupant. If the individual is recognized at step 358 as an occupant, the system, optionally, produces a greeting at step 360. In addition, and optionally, the individual may be asked to produce his confirmation code.

In accordance with a preferred embodiment of the invention, when the thermostat system is set up, for example in accordance with the methodology of method 310, an individual is designated as administrator.

At step 362 the system waits to receive the confirmation code from the individual at the door. If a valid confirmation code is received at step 362, the system checks to see if there is an alternate program assigned to that individual.

Optionally, in accordance with a preferred embodiment of the invention, at step 364 the system evaluates conflicts, priorities and preferences and executes a change in the programming, if appropriate.

After evaluating competing requirements, preferences and priorities, the system proceeds at step 366 to implement an alternative program, or parameter values.

If, on the other hand, at step 358 the system determines that the individual is not recognized as an occupant, the system proceeds to step 368 to determine whether the individual at the door is recognized. If the individual is not recognized, a default notification sequence is implemented, involving the sending of a notification, for example either locally or remotely.

If, on the other hand, at step 368, the individual at the door is recognized, the system proceeds to step 372 where it determines whether a particular action for the individual has been programmed into the system by the user. If such an action has been programmed, such action is implemented at step 374.

More particularly, in accordance with the invention, it is contemplated that numerous potential actions may be programmed for implementation by the administrator. Thus, if the system determines at step 372 that additional actions are implemented it proceeds to test for the presence of various programming options. For example, at step 376 the system determines whether a greeting has been programmed. If a greeting has been programmed, the system proceeds at step 378 to produce the greeting at doorbell communicator 58 to the individual at the door. The greeting may be oral, for example just a voice, it may be visual, such as an alphanumeric greeting addressed to the individual, such as: “Hi, Jack, nice to see you again!”

In accordance with the invention, the possibility also exists to have multiple greetings, for example depending upon the time of day. For example, if an individual appears in an office between 5 PM and 7 PM, the greeting may be: “The office is closed right now, but let me check and see if someone can help you out.” If the individual is known, a personalized message may be given by the system. Alternatively, if the individual is expected the message might be: “Hi, Jack. Bob is expecting you, just stand by a moment and someone will be out for you.”

In accordance with the invention, it is also contemplated that the message may be an audiovisual greeting, including recorded video and voice from, for example, an individual who is expecting the visitor.

Following the giving of a greeting at step 378, the system proceeds with several checks before granting the visitor admittance to the premises. First, at step 380, the system proceeds to determine whether a code is required, as would normally be the case in accordance with a preferred embodiment. If the code is required for that individual, the system presents a touchscreen keypad for entry of the code at step 382 in response to which the doors opened at step 384.

Following the granting of admission or the determination that no code is required, the system checks to see if any other action has been programmed at step 386 and performs the same at step 274. In accordance with a preferred embodiment of the invention, it is contemplated that no access will be given without the entry of a confirmatory code, even in the event that the individual is known to the system. More particularly, individuals, such as occupants of the home, would be required to use mechanical keys, RFID or other key fobs, or wait for an occupant to open the door.

As an alternative to recognition, doorbell communicator 58 may present a virtual keypad on its associated touchscreen enabling an individual to type in his name in response to an audio, alphanumeric or other invitation. Such a screen may be presented in response to an indication that the individual is not known at step 268. The system would then proceed to step 272 and through the methodology described above.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed is:

1. A method for communicating in a system comprising a smart thermostat and doorbell communicator, the method comprising:
generating a doorbell signal by a doorbell communicator, the doorbell signal indicating presence of an individual seeking entry into a facility;
receiving the doorbell signal by a smart thermostat;
generating a video signal by the doorbell communicator, the video signal comprising images of the individual seeking entry into the facility;
receiving the video signal of images of the individual seeking entry into the facility by the smart thermostat;
performing facial recognition of the images of the individual seeking entry into the facility; and,
determining, as a result of the performance of the facial recognition, whether the individual seeking entry into the facility as being identified as an occupant of the facility or a person known to the facility.

2. The method for communicating in a system comprising the smart thermostat and the doorbell communicator of claim 1, the method further comprising generating a greeting to the individual seeking entry into the facility if the individual seeking entry into the facility is recognized as an occupant of the facility by the smart thermostat.

3. The method for communicating in a system comprising the smart thermostat and the doorbell communicator of claim 2, the method further comprising receiving a confirmation code from the individual seeking entry into the facility, the confirmation code having been previously assigned to authenticate the individual seeking entry into the facility.

4. The method for communicating in a system comprising the smart thermostat and the doorbell communicator of claim 3, the method further comprising setting the desired temperature of the smart thermostat based on preferences of the individual seeking entry into the facility.

5. The method for communicating in a system comprising the smart thermostat and the doorbell communicator of claim 3, the method further comprising:
determining a priority and conflicts of the preferred settings of the smart thermostat for the individual seeking entry into the facility; and
programming the smart thermostat based on the priority and the conflicts of a plurality of occupants of the facility.

6. The method for communicating in a system comprising the smart thermostat and the doorbell communicator of claim 1, the method further comprising
generating, by the smart thermostat, a notification of the presence of the individual seeking entry not recognized as being known to the facility; and,
receiving the notification by an occupant of the facility.

7. The method for communicating in a system comprising the smart thermostat and the doorbell communicator of claim 1, the method further comprising performing programmed actions if the individual seeking entry into the facility is identified as an occupant of the facility or a person known to the facility.

8. The method for communicating in a system comprising the smart thermostat and the doorbell communicator of claim 7, wherein the programmed action comprises generating a programmed message to the individual seeking entry into the facility.

9. The method for communicating in a system comprising the smart thermostat and the doorbell communicator of claim 7, wherein the programmed action comprises:
determining whether a confirmation code is required by the individual seeking entry into the facility;
receiving the code from the individual seeking entry into the facility; and,
opening a door for the individual seeking entry into the facility.

10. The method for communicating in a system comprising the smart thermostat and the doorbell communicator of claim 1, further comprising generating by the smart thermostat, a ringtone in response to the doorbell signal received by a smart thermostat.

11. The method for communicating in a system comprising the smart thermostat and the doorbell communicator of claim 10, further comprising communicating the ringtone signal to a remote smart phone.

12. A method for communicating in a system comprising a smart thermostat and doorbell communicator, the method comprising:
generating a video signal of an individual seeking entry into a facility;
receiving the video signal of images of the individual seeking entry into the facility by a device;
performing facial recognition of the images of the individual seeking entry into the facility; and,
determining via the performance of the facial recognition whether the individual seeking entry into the facility as being identified as an occupant of or known to the facility.

13. The method for communicating in a system comprising the smart thermostat and the doorbell communicator of claim 12, the method further comprising generating a greeting to the individual seeking entry into the facility if the individual seeking entry into the facility is recognized as an occupant of the facility by the smart thermostat.

14. The method for communicating in a system comprising the smart thermostat and the doorbell communicator of claim 13, the method further comprising receiving a confirmation code from the individual seeking entry into the facility, the confirmation code having been previously assigned to authenticate the individual seeking entry into the facility.

15. The method for communicating in a system comprising the smart thermostat and the doorbell communicator of claim 13, the method further comprising setting the desired temperature of the smart thermostat based on preferences of the individual seeking entry into the facility.

16. The method for communicating in a system comprising the smart thermostat and the doorbell communicator of claim 14, the method further comprising:
determining a priority and conflicts of the preferred settings of the smart thermostat for the individual seeking entry into the facility; and
programming the smart thermostat based on the priority and the conflicts of a plurality of occupants of the facility.

17. A method for communicating in a system comprising a smart thermostat and doorbell communicator, the method comprising:
generating a doorbell signal by a doorbell communicator, the doorbell signal indicating presence of an individual seeking entry into a facility;
receiving the doorbell signal by the smart thermostat;
generating a video signal by the doorbell communicator;
receiving the video signal of images of the individual seeking entry into the facility by the smart thermostat;
analyzing the images of the individual seeking entry into the facility to identify the individual seeking entry into the facility; and,
determining, as a result of the performance of the identification of individual seeking entry into the facility, whether the individual seeking entry into the facility as being identified as an occupant of the facility or a person known to the facility.

18. The method for communicating in a system comprising the smart thermostat and the doorbell communicator of claim 17, wherein analyzing the images of the individual seeking entry into the facility to identify the individual seeking entry into the facility comprises performing facial recognition on the individual seeking entry into the facility.

19. The method for communicating in a system comprising the smart thermostat and the doorbell communicator of claim 17, wherein analyzing the images of the individual seeking entry into the facility to identify the individual seeking entry into the facility comprises determining the psychological state of the individual seeking entry into the facility.

20. The method for communicating in a system comprising the smart thermostat and the doorbell communicator of claim 17, the method further comprising setting the desired temperature of the smart thermostat based on preferences of the individual seeking entry into the facility.
